(19) United States
(12) Patent Application Publication
(10) Pub. No.: US 2024/0262708 A1
(43) Pub. Date: Aug. 8, 2024

(54) METHOD OF MANUFACTURING POSITIVE ELECTRODE ACTIVE MATERIAL

(71) Applicant: Toyota Jidosha Kabushiki Kaisha, Toyota-shi Aichi-ken (JP)

(72) Inventors: So Yubuchi, Sunto-gun Shizuoka-ken (JP); Masahiro Morimoto, Susono-shi Shizuoka-ken (JP)

(73) Assignee: Toyota Jidosha Kabushiki Kaisha, Toyota-shi Aichi-ken (JP)

(21) Appl. No.: 18/420,371

(22) Filed: Jan. 23, 2024

(30) Foreign Application Priority Data
Jan. 27, 2023 (JP) 2023-010972

(51) Int. Cl. C01G 53/00; H01M 4/02; H01M 4/505

(52) U.S. Cl. CPC C01G 53/50; H01M 4/505; C01P 2002/52; C01P 2002/90; C01P 2006/40; H01M 2004/028

(57) ABSTRACT

Disclosed is a method of increasing the capacity of an O2 type positive electrode active material. The method of manufacturing a positive electrode active material according to the present disclosure comprises firing a precursor containing Na and transition metal elements, followed by cooling to obtain a Na containing transition-metal oxide having a P2 type structure; and replacing at least a portion of Na of the Na containing transition-metal oxide with Li by ion-exchange to obtain a positive electrode active material having an O2 type structure, wherein after firing the precursor, the cooling rate from 250° C. to cooling end-temperature is 20° C./min or higher.

### CROSS-REFERENCE TO RELATED APPLICATIONS

This application claims priority to Japanese Patent Application No. 2023-010972 filed Jan. 27, 2023, the entire contents of which are herein incorporated by reference.

### FIELD

The present application discloses a method of manufacturing a positive electrode active material.

### BACKGROUND ART

Positive electrode active materials having an O2 type structure are known (O: Octahedral). The positive electrode active material with an O2-type structure can be obtained by ion-exchange of Li for at least a portion of Na in a Na-containing transition metal oxide with a P2-type structure, as disclosed in PTL 1.

### CITATION LIST

### Patent Literature

[PTL 1] JP 2014-186937 A

### SUMMARY

### Technical Problem

Conventional positive electrode active materials having O2 type structures have room for improved capacities.

### Solution to Problem

The present application discloses the following aspects for solving this problem.

### <Aspect 1>

A method of manufacturing a positive electrode active material, the method comprising: obtaining a Na containing transition-metal oxide having a P2 type structure; and
replacing at least a portion of Na of the Na containing transition-metal oxide with Li by ion-exchange to obtain the positive electrode active material having an O2 type structure, wherein
the water content of the Na containing transition-metal oxide is 1000 ppm or less.

### <Aspect 2>

A method of manufacturing a positive electrode active material, the method comprising:
firing a precursor containing Na and transition metal elements, followed by cooling to obtain a Na content transition metal oxide having a P2 type structure; and
replacing at least a portion of Na of the Na containing transition-metal oxide with Li by ion-exchange to obtain the positive electrode active material having an O2 type structure, wherein
after firing the precursor, the cooling rate from 250° C. to cooling end-temperature is 20° C./min or higher.

### <Aspect 3>

The method according to Aspect 2, wherein
the firing the precursor is performed in a heating furnace,
the cooling from 250° C. to the cooling end-temperature is performed outside the heating furnace.

### <Aspect 4>

The method according to any one of Aspects 1 to 3, wherein
the positive electrode active material has a chemical composition represented by

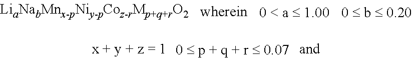

element M is at least one of B, Mg, Al, K, Ca, Ti, V, Cr, Fe, Cu, Zn, Ga, Ge, Sr, Y, Zr, Nb, Mo and W.

### Effects

The positive electrode active material of the present disclosure has a high capacity.

### BRIEF DESCRIPTION OF DRAWINGS

FIG. 1 shows an example of a flow of a method of manufacturing a positive electrode active material according to the first embodiment.

FIG. 2 shows an example of a flow of a method of manufacturing a positive electrode active material according to the second embodiment.

FIG. 3 shows the firing conditions of the precursor in Example 1.

FIG. 4 shows the relation between the water content of P2 type Na containing transition-metal oxide and the discharge capacity of the coin cell.

### DESCRIPTION OF EMBODIMENTS

### 1. Method of Manufacturing a Positive Electrode Active Material (First Embodiment)

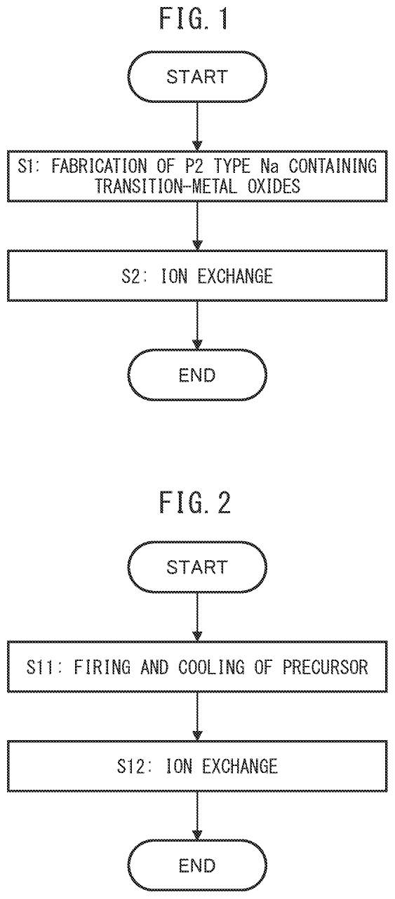

As shown in FIG. 1, the method of manufacturing a positive electrode active material according to the first embodiment includes obtaining a Na containing transition-metal oxide having a P2 type structure (Step S1), and replacing at least a portion of Na of the Na containing transition-metal oxide with Li by ion-exchange to obtain the positive electrode active material having an O2 type structure (Step S2), wherein the water content of Na containing transition-metal oxide is 1000 ppm or less.

### 1.1 Step S1

A positive electrode active material having an O2 type structure is produced by obtaining a Na containing transition-metal oxide having a P2 type structure similar to O2 type structure, and then ion-exchanging at least a part of Na of the Na containing transition-metal oxide with Li. Here, according to the findings of the present inventors, H₂O molecules are easily incorporated between layers of the P2 type structure. The P2 type structure collapses when H₂O molecules are incorporated between the layers of the P2 type structure, which may restrict Na conductivity path. In other words, if the Na containing transition-metal oxide having a large water content is used, even if an attempt is made to ion-exchange Na of the oxide with Li, ion exchange is difficult to proceed, and a desired O2 type structure may not be obtained. The present inventor has found that, in the step S1, a Na containing transition-metal oxide having a P2 type structure having a water content of 1000 ppm or less is obtained, and then the step S2 is performed using the same, whereby the above problem can be solved.

In the step S1, a Na containing transition-metal oxide having a P2 type structure can be obtained by, for example, obtaining a precursor containing Na and a transition metal element, optionally shaping the precursor, and optionally preliminarily firing the precursor, and then performing the main firing.

In the step S1, the precursor may be obtained, for example, by mixing a transition-metal source and a Na source. The transition metal source may be, for example, a transition metal salt such as carbonate, sulfate, nitrate, acetate, or the like, or a transition metal compound such as a transition metal hydroxide. The transition-metal element may be at least one of Mn, Ni and Co. The transition metal source may be a salt represented by Me(CO₃)ₓ (Me is at least one transition metal element of Mn, Ni and Co, and x depends on the Me valence) or may be a salt represented by Me(SO₄)ₓ or may be a salt represented by Me(CH₃COO)ₓ, or may be a compound represented by Me(OH)ₓ. Further, Na source may be, for example, a Na salt such as carbonate or sulfate, or a Na compound such as sodium oxide or sodium hydroxide. The quantity of the Na source to be mixed with respect to the transition-metal source may be determined by taking into account Na loss during subsequent firing. In step S1, the surface of the particle comprising the transition-metal source described above may be covered with a Na source to obtain a covered particle as the precursor. Here, the covered particle may be obtained by covering at least a part of the surface of the particle of the transition-metal source described above with the Na source. The covered particle may be obtained by covering 40 area % or more, 50 area % or more, 60 area % or more or 70 area % or more of the surface of the particle of the above-described transition-metal source.

In the step S1, the precursor may be obtained, for example, by mixing an M source comprising an element M in addition to the transition-metal source and the Na source. Here, the element M is at least one of B, Mg, Al, K, Ca, Ti, V, Cr, Fc, Cu, Zn, Ga, Ge, Sr, Y, Zr, Nb, Mo and W. P2 type structure and O2 type structure can be further stabilized by the element M. The M source may be, for example, a salt such as nitrate, sulfate, carbonate, acetate, or the like, or a compound other than a salt such as hydroxide. The amount of the M source in the precursor may be appropriately determined depending on the target composition of Na content transition-metal oxide after firing.

In the step S1, the precursor may be obtained, for example, by mixing the precipitate with the Na source after obtaining the precipitate using an ion source capable of forming a precipitate with a transition metal ion in an aqueous solution and a transition metal compound. Ion sources which may form precipitates with the transition metal ions include, for example, sodium salt such as sodium carbonate and sodium nitrate, sodium hydroxide, sodium oxide, and the like. Examples of the transition metal compound include salts such as nitrate, sulfate, carbonate and acetate, and hydroxides. In the step S1, a precipitate may be obtained by preparing solution of the ion source and solution of the transition-metal compound and dropping and mixing each solution. At this time, various sodium compounds may be used as the base, and an aqueous ammonia solution or the like may be added to adjust the basicity. More particularly, in the step S1, the precipitate containing at least one transition-metal element of Mn, Ni and Co may be obtained. The precipitate may be obtained by, for example, a solution method such as a coprecipitation method or a sol-gel method. Specifically, for coprecipitation, the precipitate is obtained by, for example, preparing a Me(SO₄)ₓ solution and an Na₂CO₃ solution and dropping and mixing each solution. The precipitate may be collected and then mixed with the Na source. The quantity of the Na source to be mixed with respect to the precipitate may be determined by taking into consideration the amount of Na disappearance during subsequent firing. Further, the surface of the particle of the precipitate may be covered with a Na salt to obtain the covered particle as the precursor. Here, the covered particles may be obtained by covering at least a part of the surface of the particle of the precipitate described above with a Na salt. The covered particle may be obtained by covering 40 area % or more, 50 area % or more, 60 area % or more or 70 area % or more of the surface of the particle of the above-mentioned precipitate with the Na salt.

In the step S1, pre-firing of the precursor obtained as described above may be performed at a temperature below the main firing. For example, it is possible to perform pre-firing at a temperature below 700° C. The pre-firing time is not particularly limited. Alternatively, pre-firing may be omitted.

In the step S1, the main firing of the precursor may be performed, for example, at a temperature of 700° C. or higher and 1100° C. or lower. In some embodiments, it is 800° C. or higher and 1000° C. or lower. If the main firing temperature is too low, Na doping is not performed, and if the main firing temperature is too high, O3 type structure rather than P2 type structure is likely to be generated. The temperature rising condition from the pre-firing temperature to the main firing temperature is not particularly limited. The main firing time is also not particularly limited, and may be, for example, 30 minutes or more and 10 hours or less. The main firing atmosphere is also not particularly limited, and may be, for example, an oxygen-containing atmosphere such as an air atmosphere or an inert gas atmosphere.

In the step S1, the Na containing transition-metal oxide having a P2 type structure is obtained by cooling after the main firing. Here, as will be described later as the second embodiment, by controlling the cooling rate after the main firing, the water content contained in the Na containing transition-metal oxide can be reduced. Alternatively, it is also possible to reduce the amount of water content in the Na containing transition-metal oxide by cooling in an atmosphere having a small amount of water.

In the step S1, after the main firing described above, the element M described above may be doped to the Na containing transition-metal oxide having a P2 type structure. In other words, after synthesizing the Na containing transition-metal oxide having a P2 type structure and containing no element M, doping of the element M may be performed on the oxide. Doping of the element M may be performed, for example, by ion exchange.

The Na containing transition-metal oxide obtained by the step S1 may be, for example, one containing at least one element among Mn, Ni and Co, Na, and O as a constituent element. In particular, in the case at least Na, Mn, and at least one of Ni and Co, and O are contained, among them, at least Na, Mn, Ni, Co, and O are contained as a constituent element, the performance of the positive electrode active material tends to be further increased. More specifically, the Na containing transition metal oxide obtained by the step S1 may have a chemical composition represented by Na_{c}Mnₓ₋ₚNi_{y-q}CO_{z-r}M_{p+q+r}O₂ (here, 0<c≤1.00, x+y+2=1, and, 0≤p+q+r≤0.07, element M is at least one of B, Mg, Al, K, Ca, Ti, V, Cr, Fc, Cu, Zn, Ga, Ge, Sr, Y, Zr, Nb, Mo and W). When the Na containing transition-metal oxide has such a chemical composition, P2 type structure is more easily maintained. In the above chemical composition, c may be more than 0, 0.10 or more, 0.20 or more, 0.30 or more, 0.40 or more, 0.50 or more or 0.60 or more, and may be 1.00 or less, 0.90 or less, 0.80 or less or 0.70 or less. Further, x may be 0 or more, 0.10 or more, 0.20 or more, 0.30 or more, 0.40 or more, or 0.50 or more, and may be 1.00 or less, 0.90 or less, 0.80 or less, 0.70 or less, 0.60 or less, or 0.50 or less. In addition, y may be 0 or more, 0.10 or more, or 0.20 or more, and may be 1.00 or less, 0.90 or less, 0.80 or less, 0.70 or less, 0.60 or less, 0.50 or less, 0.40 or less, 0.30 or less, or 0.20 or less. Further, z may be 0 or more, 0.10 or more, 0.20 or more, or 0.30 or more, and may be 1.00 or less, 0.90 or less, 0.80 or less, 0.70 or less, 0.60 or less, 0.50 or less, 0.40 or less, or 0.30 or less. p+q+r may be 0 or more, more than 0, 0.01 or more, 0.02 or more or 0.03 or more, and may be 0.07 or less, 0.06 or less, 0.05 or less or 0.04 or less. The composition of O is approximately 2, but is variable without being limited to exactly 2.0.

As described above, in the step S1, for example, by controlling the cooling atmosphere or the cooling rate or the like, the water content of the Na containing transition-metal oxide can be reduced. In embodiments, the water content of the Na containing transition-metal oxide obtained by the step S1 is 1000 ppm or less. The water content may be 900 ppm or less, 850 ppm or less, 800 ppm or less, 750 ppm or less, 700 ppm or less, 650 ppm or less, 600 ppm or less, or 550 ppm or less. There is no particular limitation on the lower limit of the water content, and may be 0 ppm or more, 10 ppm or more, 50 ppm or more, or 100 ppm or more. Note that the water content is a ratio of the mass of water to the total mass of the Na containing transition-metal oxide. In other words, 1000 ppm or less means 0.1% by mass or less. The “water content of Na containing transition-metal oxide” referred to in the present application is a water content at 200° C., which is measured by Karl Fischer titration.

### 1.2 Step S2

In the step S2, at least a portion of Na of the Na containing transition-metal oxide obtained by the step S1 is replaced with Li by ion-exchange to obtain a positive electrode active material having an O2 type structure. In the step S2, for example, at least a portion of the Na containing transition-metal oxide can be replaced with Li by ion-exchange using a lithium-salt. For example, by mixing the Na containing transition metal oxide having a P2 type structure with a lithium salt and then heating the mixture to a temperature equal to or higher than a melting point of the lithium salt to melt the lithium salt, at least a part of Na can be replaced with Li by ion-exchange. The lithium salt may be, for example, lithium halide. The lithium halide may be at least one of lithium chloride, lithium bromide and lithium iodide. Alternatively, the lithium salt may be lithium nitrate. Alternatively, the lithium salt may be a mixed salt of lithium halide and lithium nitrate.

In the step S2, the element M may be doped at the time of ion-exchange described above. For example, the oxide can be doped with an element M by heating and melting the salt containing the element M and then contacting the Na containing transition-metal oxide described above with the melted salt. Examples of the salt containing element M include a halide of element M. In addition, in the step S2, at least a part of Na of the Na containing transition-metal oxide may be ion-exchanged into Li and the element M may be doped by contacting the salt containing Li and the element M with the Na containing transition metal oxide described above. When the salt containing Li and the element M (a mixed salt of a lithium salt and a salt of the element M, or a complex salt of Li and the element M) is used, the melting point of the salt may be lowered than when each of the lithium salt and the salt of the element M is used alone. In particular, when a salt containing Li and at least one of Al and Ga as the element M is used, the melting point tends to be greatly lowered. In other words, the temperature required for melting is lowered, and the ion-exchange of the above Li and the doping of the element M can be performed at a low temperature. The mixing ratio of the lithium salt and the salt of the element M is not particularly limited. Specific examples of the salt containing Li and element M include, for example, a salt containing Li, element M and halogen (a mixed salt of lithium halide and a halide of the element M, or a complex halide of Li and the element M).

Temperature in the step S2 (for example, heating temperature in the case of carrying out melt ion-exchange by contacting a lithium salt to the Na containing transition-metal-oxide particle) may be, for example, 600° C. or lower, 500° C. or lower, 400° C. or lower, 350° C. or lower, 300° C. or lower, 280° C. or lower, 250° C. or lower, 230° C. or lower, 200° C. or lower, 170° C. or lower, or 150° C. or lower, and it may be above room temperature, or 100° C. or higher. If the temperature is too high, an O3 type structure which is a stable phase is easily generated rather than an O2 type structure. When the lithium salt is melted, it may be heated above the melting point of the lithium salt as described above. The time in the step S2 (e.g., the heating time when the lithium salt is heated and melted after being contacted with the Na containing transition metal oxide to perform ion-exchange) may be adjusted so that most of Na of the Na containing transition-metal oxide is replaced with Li. From the viewpoint of ensuring a sufficient time for the lithium salt to melt, for example, the time in the step S2 may be, for example, 10 minutes or more or 60 minutes or more, and may be 12 hours or less or 6 hours or less. The atmosphere in the step S2 is not particularly limited, and may be, for example, an oxygen-containing atmosphere such as an air atmosphere or an inert gas atmosphere. After ion-exchange, some post-treatment such as cleaning may be performed on Li containing transition-metal oxide having an O2 type structure.

### 2. Method of Manufacturing a Positive Electrode Active Material (Second Embodiment)

As shown in FIG. 2, a method of manufacturing a positive electrode active material according to the second embodiment includes firing a precursor containing Na and transition metal elements, followed by cooling to obtain a Na containing transition metal oxide having a P2 type structure (step S11); and replacing at least a portion of Na of the Na containing transition-metal oxide with Li by ion-exchange to obtain a positive electrode active material having an O2 type structure (step S12), wherein after firing the precursor, the cooling rate from 250° C. to cooling end-temperature is 20° C./min or higher.

### 2.1 Step S11

Since the conditions for preparing the precursor and the conditions for firing the precursor in the step S11 are the same as those in the step S1 of the above-described first embodiment, a detailed explanation thereof will be omitted here. In the step S11, it is characterized that the precursor after firing is cooled by high-speed cooling at a cooling rate of 20° C./min or higher when cooling at least from 250° C. to the cooling-end temperature. For example, after firing the precursors at a firing temperature of 700° C. or higher and 1100° C. or less, starting the cooling from the firing temperature, controlling the cooling so that the cooling rate between at least 250° C. to the cooling end temperature is 20° C./min or higher.

In the step S11, after firing of the precursor, the cooling rate from the firing temperature to 250° C. is not particularly limited. For example, the cooling rate from the firing temperature to 250° C. may be 20° C./min or higher, or may be less than 20° C./min. There is no particular limitation on the cooling atmosphere between the firing temperature to 250° C. For example, it may be cooled in the same atmosphere as the firing atmosphere.

In the step S11, the cooling rate from 250° C. to the cooling end-temperature is 20° C./min or higher. The “cooling end temperature” may be any temperature of 100° C. or lower. The cooling end temperature is not necessarily the temperature cooling is completely terminated (cooling is stopped) and may be any temperature 100° C. or lower. For example, when firing of the precursor is performed in the heating furnace, the cooling end temperature may be the same as the temperature outside the heating furnace. In the step S11, for example, a cooling rate from 250° C. to 100° C. may be 20° C./min or higher, a cooling rate from 250° C. to 50° C., may be 20° C./min or higher, or a cooling rate from 250° C. to 25° C. may be 20° C./min or higher. The cooling rate may be 21° C./min or higher or 22° C./min or higher. The upper limit of the cooling rate is not particularly limited, and may be, for example, 100° C./min or less, 80° C./min or less, 60° C./min or less or 40° C./min or less.

In the step S11, the firing of the precursor may be performed in a heating furnace, and the cooling from 250° C. to the cooling end-temperature may be performed outside the heating furnace. For example, in the step S11, the precursor may be fired in the heating furnace to obtain a P2 type Na containing transition-metal oxide, and the Na containing transition-metal oxide may be taken out of the heating furnace at an optional temperature of 250° C. or higher, and cooled. By cooling in the outside of the heating furnace (e.g., air cooling) at least from 250° C. to the cooling end temperature, the cooling rate from 250° C. to the cooling end temperature can be 20° C./min or more. A known heating furnace such as muffle furnace or electric furnace may be used.

In the step S11, the precursor after firing are rapidly cooled at a cooling rate of 20° C./min or higher at least from 250° C. to the cooling end temperature whereby it is difficult for moisture to enter between the layers of P2 type structure and it is possible to reduce the amount of moisture content in the Na containing transition-metal oxide obtained after completion of cooling. For example, the water content in the Na containing transition-metal oxide may be 1000 ppm or less, 900 ppm or less, 850 ppm or less, 750 ppm or less, 700 ppm or less, 650 ppm or less, 600 ppm or less, or 550 ppm or less. There is no particular limitation on the lower limit of the water content, and may be 0 ppm or more, 10 ppm or more, 50 ppm or more, or 100 ppm or more. According to the estimation of the present inventor, in a predetermined temperature range from 250° C. to the cooling-end temperature, moisture is easily intruded between the layers of P2 type structure by atomic vibration, molecular motion, or the like. It is considered that, when the Na containing transition-metal oxide having P2 type structure is cooled, the amount of moisture entering into the layer of P2 type structure is reduced by making a time in which such moisture tends to enter the layer a short time (that is, high speed cooling).

### 2.2 Step S12

Since the step S12 is the same as the step S2 in the first embodiment, a detailed explanation thereof will be omitted here.

### 3. Positive Electrode Active Material

As described above, according to the method of manufacturing a positive electrode active material according to the first embodiment or the second embodiment, a positive electrode active material having an O2 type structure (an O2 type Li containing transition-metal oxide) can be produced. Here, it can be said that the Na containing transition-metal oxide used in the step S2 or S12 has a small water content, and the crystalline structure of P2 type is appropriately maintained, and Na conductivity path is appropriately maintained. By using such a Na containing transition-metal oxide, Na can be efficiently ion-exchanged into Li in the step S2 or S12.

### 3.1 Crystal Structure

The positive electrode active material has at least an O2 type structure (belonging to the space group P63mc). The positive electrode active material may have an O2-type structure while also having a crystal structure other than an O2-type structure. Examples of crystal structures other than an O2-type structure include a T#2-type structure (belonging to space group Cmca) or an 06-type structure (belonging to space group R-3m, with a c-axis length of 2.5 nm to 3.5 nm and typically 2.9 nm to 3.0 nm, and differing from an O3-type structure which also belongs to space group R-3m), formed when Li is intercalated/deintercalated from an O2-type structure. The positive electrode active material may have an O2-type structure as the main phase, or may have a crystal structure other than an O2-type structure as the main phase. In some embodiments, the positive electrode active material has an O2-type structure as the main phase. The positive electrode active material may have a crystal structure for the main phase that changes depending on the state of charge-discharge.

### 3.2 Chemical Composition

The positive electrode active material may contain at least one of Mn, Ni and Co, Li, and O as constituent elements. If at least Li, Mn, one or more from among Ni and Co, and O are included as constituent elements, and especially if at least Li, Mn, Ni, Co and O are included as constituent elements, then high performance is easily obtained. In the positive electrode active material, for example, Li may be almost completely released by charging, and the molarity of Li may be close to 0. In addition, the positive electrode active material may contain Na as a constituent element due to the above-described manufacturing process. Further, the positive electrode active material may contain the above element M. Further, the positive electrode active material may contain other impurity elements. The chemical composition of the positive active material may be LiₐNa_{b}Mnₓ₋ₚNi_{y-q}CO_{z-r}M_{p+q+r}O₂ (here, 0<a≤1.00, 0≤b≤0.20, x+y+2=1, and, 0≤p+q+r≤0.07, element M is at least one of B, Mg, Al, K, Ca, Ti, V, Cr, Fe, Cu, Zn, Ga, Ge, Sr, Y, Zr, Nb, Mo and W). In the chemical composition, “a” may be more than 0, 0.10 or more, 0.20 or more, 0.30 or more, 0.40 or more, 0.50 or more, or 0.60 or more, and may be 1.00 or less, 0.90 or less, 0.80 or less or 0.70 or less. In addition, “b” may be 0 or more, or more than 0, and may be 0.15 or less, 0.10 or less, 0.05 or less, 0.04 or less, 0.03 or less, 0.02 or less, or 0.01 or less. Further, “x” may be 0 or more, 0.10 or more, 0.20 or more, 0.30 or more, 0.40 or more, or 0.50 or more, and may be 1.00 or less, 0.90 or less, 0.80 or less, 0.70 or less, 0.60 or less, or 0.50 or less. In addition, “y” may be 0 or more, 0.10 or more, or 0.20 or more, and may be 1.00 or less, 0.90 or less, 0.80 or less, 0.70 or less, 0.60 or less, 0.50 or less, 0.40 or less, 0.30 or less, or 0.20 or less. Further, “z” may be 0 or more, 0.10 or more, 0.20 or more, or 0.30 or more, and may be 1.00 or less, 0.90 or less, 0.80 or less, 0.70 or less, 0.60 or less, 0.50 or less, 0.40 or less, or 0.30 or less. The element M is small contribution to charge and discharge. In this regard, in the above chemical composition, when p+q+r is 0.07 or less, a high charge/discharge capacity is easily secured. p+q+r may be 0.06 or less, 0.05 or less, or 0.04 or less. On the other hand, by containing the element M, the O2 type structure is easily stabilized. In this regard, in the chemical composition described above, p+q+r is 0 or more, and may be more than 0, 0.01 or more, 0.02 or more, or 0.03 or more. The composition of O is approximately 2, but is variable without being limited to exactly 2.0. In addition, in the above chemical composition of the positive electrode active material, when the valence of the element M is set to +n, a relationship of 3.0≤4(x−p)+2(y−q)+3(z−r)+n(p+q+r)≤3.5 may be satisfied. This is intended to have a range in which the total valence of the metal in the positive electrode active material is close to 3.33 valence (charge neutrality when a is 0.67). As described above, a positive electrode active material having an O2 type structure passes through a Na containing transition-metal oxide having a P2 type structure at the time of synthesizing thereof, but it becomes charge-neutral in a range in which Na composition at this time becomes 0.5 or more and 1.0 or less, corresponds to a case where the above relationship is satisfied.

### 3.3 Shape

The positive electrode active material may be particulate. The positive electrode active material particles may be solid particles, may be hollow particles, or may be those having a void. The positive electrode active material particles may be primary particles or secondary particles in which a plurality of primary particles are aggregated. Average particle diameter (D50) of the positive active material particle may be, for example, 1 nm or more, 5 nm or more or 10 nm or more, and 500 μm or less, 100 μm or less, 50 μm or less or 30 μm or less. The average particle diameter D50 as referred to in the present application is the particle diameter (median diameter) at an integrated value of 50% in the particle size distribution on a volume basis determined by a laser diffraction/scattering method.

### 4. Method of Manufacturing a Lithium Ion Battery

The positive electrode active material produced as described above is used, for example, as a positive electrode active material of a lithium ion battery. The lithium ion battery can be manufactured, for example, as follows, but is not limited thereto, and each layer may be formed by dry molding or the like.
(1) The positive electrode active material that is to form the positive electrode active material layer is dispersed in a solvent to obtain a positive electrode layer slurry. The solvent used may be, but is not limited to, water or an organic solvent. A doctor blade is used to coat the positive electrode layer slurry onto the surface of a positive electrode collector, and it is then dried to form a positive electrode active material layer on the positive electrode collector surface, obtaining a positive electrode.
(2) The negative electrode active material that is to form the negative electrode active material layer is dispersed in a solvent to obtain a negative electrode layer slurry. The solvent used may be, but is not limited to, water or an organic solvent. A doctor blade is used to coat the negative electrode layer slurry onto the surface of a negative electrode collector, and it is then dried to form a negative electrode active material layer on the negative electrode collector surface, obtaining a negative electrode.
(3) Each layer is stacked with the electrolyte layer (solid electrolyte layer or separator) sandwiched between the negative electrode and positive electrode, to obtain a stack having a negative electrode collector, negative electrode active material layer, electrolyte layer, positive electrode active material layer and positive electrode collector in that order. Terminals and other members are attached to the stack as necessary.
(4) The stack is housed in a battery case, the battery case then being filled with electrolyte solution in the case of an electrolyte battery, and the stack inside the battery case is sealed with the stack immersed in the electrolyte solution, to obtain a secondary battery. For an electrolyte battery, the electrolyte solution may be added to the negative electrode active material layer, separator and positive electrode active material layer at stage (3).

### EXAMPLES

As described above, an embodiment of a method of manufacturing a positive electrode active material of the present disclosure has been described, but various modifications can be made to the method of manufacturing a positive electrode active material of the present disclosure other than the above embodiment without departing from the gist thereof. Hereinafter, the technique of the present disclosure will be described in further detail with reference to Examples, but the technique of the present disclosure is not limited to the following Examples.

### 1. Preparing Precursor (Mixture of Transition-Metal Source and Na Source)

### 1.1 Coprecipitation Synthesis of Transition Metal Sources

After weighing out MnSO₄·5H₂O, NiSO₄·6H₂O and CoSO₄·7H₂O to the target compositional ratio, they were dissolved in distilled water to a concentration of 1.2 mol/L to obtain a first solution. In a separate container, Na₂CO₃ was dissolved in distilled water to a concentration of 1.2 mol/L to obtain a second solution. Subsequently, 500 mL of the first liquid and the second liquid described above were added dropwise to a reactor in which pure water of 1000 mL was previously placed at a rate of about 4 mL/min respectively. After completion of the dropwise addition, the mixture was 1 h stirred at room temperature at 150 rpm a stirring rate. The precipitate was washed with pure water and subjected to solid-liquid separation in a centrifuge. The obtained precipitate was dried at 120° C. overnight, and the fine particles were removed by air flow classification after mortar grinding to obtain mixed salt particles (transition-metal source) containing Mn, Ni and Co.

### 1.2 Mixing of Transition-Metal Source and Na Source (Na Coating)

An aqueous Na₂CO₃ solution was prepared by weighing Na₂CO₃ and distilled water so as to be a 1150 g/L, and then stirring using a stirrer until completely dissolved. The above mixed salt-particles were mixed with the Na₂CO₃ aqueous solution to obtain a slurry. Na₂CO₃ and the above mixed salt particles were mixed so as to have composition of Na_{0.7}Mn_{0.5}Ni_{0.2}Co_{0.3}O₂ after being dried. The slurry was dried by spray drying. Specifically, a spray dryer DL410 was used to coat the surface of the above-mentioned mixed salt with Na₂CO₃ under the conditions of a slurry liquid feed rate of 30 mL/min, an inlet temperature of 200° C., a circulating air volume of 0. 8 m³/min, and a spray air pressure of 0.3 MPa to obtain precursor particles.

### 2. Firing of the Precursor Particles

### 2.1 Example 1

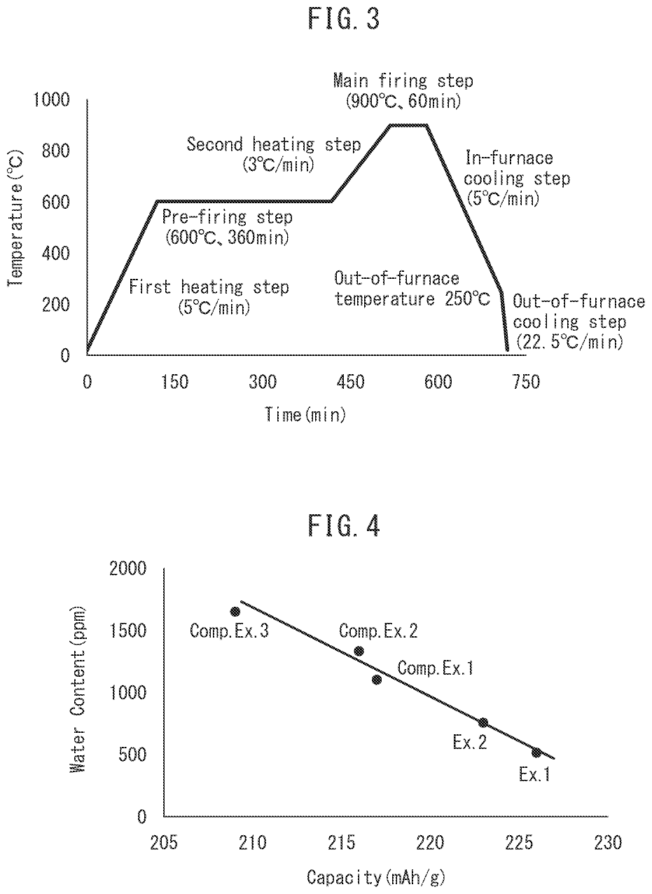

The precursor particles were fired in an electric furnace using an alumina crucible under an air atmosphere (humidity of 50% or more). Specifically, with respect to the precursor particles, “first heating step”, “pre-firing step”, “second heating step”, “main firing step”, “in-furnace cooling step” and “out-of-furnace cooling step” as shown in Table 1 and FIG. 3 below were performed. Note that the “in-furnace cooling step” refers to the cooling step in the electric furnace, and the “out-of-furnace cooling step” refers to the step of cooling the atmosphere outside the electric furnace. Thereafter, by performing grinding in a mortar at a dew point of −30° C. or less, a Na containing transition-metal oxide (Na_{0.7}Mn_{0.5}Ni_{0.2}Co_{0.3}O₂) having a P2 type structure was obtained. The resulting Na containing transition-metal oxide was stored in a dry room (dew point −30° C. or less).

TABLE 1

| | Starting | Finishing | | Heating Rate or |
|---|---|---|---|---|
| | Temperature | Temperature | Time | Cooling Rate |
| Step | (° C.) | (° C.) | (min) | (° C./min) |
| First Heating | 25 | 600 | 115 | 5 |
| Pre-Firing | 600 | 600 | 360 | 0 |
| Second Heating | 600 | 900 | 60 | 3 |
| Main Firing | 900 | 900 | 60 | 0 |
| In-furnace cooling | 900 | 250 | 130 | 5 |
| Out-of-furnace | 250 | 25 | 10 | 22.5 |
| cooling | | | | |

### 2.2 Example 2

The same steps as in Example 1 were carried out except that the obtained Na containing transition-metal oxide was stored in an atmosphere of 50% humidity.

### 2.3 Comparative Example 1

The same steps as in Example 1 were carried out except that the finish temperature of in-furnace cooling (temperature taken out to the outside of the furnace) was 200° C., the time of in-furnace cooling was 140 minutes, the starting temperature of out-of-furnace cooling was 200° C., and the cooling rate of out-of-furnace cooling was 17.5° C./min.

### 2.4 Comparative Example 2

The same steps as in Example 1 were carried out except that the finish temperature of in-furnace cooling (temperature taken out to the outside of the furnace) was 150° C., the time of in-furnace cooling was 150 minutes, the starting temperature of out-of-furnace cooling was 150° C., and the cooling rate of out-of-furnace cooling was 12.5° C./min.

### 2.5 Comparative Example 3

The same steps as in Example 1 were carried out except that the finish temperature of in-furnace cooling (temperature taken out to the outside of the furnace) was 100° C., the time of in-furnace cooling was 160 minutes, the starting temperature of out-of-furnace cooling was 100° C., and the cooling rate of out-of-furnace cooling was 7.5° C./min.

### 3. Identification of Water Content

The water content at 200° C. in each Na containing transition-metal oxide described above was measured by Karl Fischer titration.

### 4. Ion Exchange

LiNO₃ and LiCl were weighed to a molar ratio of 50:50 and mixed with the Na containing transition-metal oxide described above at a molar ratio of 10 times the minimum Li required for ion-exchange to obtain a mixture. Subsequently, firing was performed for 1 h at 280° C. using an alumina crucible in an air atmosphere (at least 50% humid). The salt remaining after firing was washed with pure water and solid-liquid separated by vacuum filtration. By drying the obtained precipitate overnight at 120° C., a Li containing transition-metal oxide (LiₐMn_{0.5}Ni_{0.2}Co_{0.3}O₂) having an O2 type structure was obtained as a positive electrode active material. The compositional ratio “a” of Li was about 0.6.

### 5. Making a Coin Cell

The positive electrode active material described above, acetylene black (AB) as a conductive material, and PVdF as a binder were weighed so as to have a mass-ratio of positive electrode active material:AB:PVdF=85:10:5, and dispersed and mixed in N-methyl-2-pyrrolidone to obtain a positive electrode slurry. The positive electrode slurry was coated on an Al foil and vacuum-dried overnight at 120° C., thereby obtaining a positive electrode. A coin cell (CR2032) was prepared using the obtained positive electrode, an electrolytic solution (TDDK-217, manufactured by Daikin Co., Ltd.) and a metallic Li foil as a negative electrode.

### 6. Evaluation of the Coin Cell

In a thermostatic bath held at 25° C., charge and discharge were performed at voltage-range 2-4.8V, 0.1 C (1 C=220 mA/g), and the discharge capacities were measured.

### 7. Evaluation Results

Table 2 below and FIG. 4 show the water content contained in the Na containing transition-metal oxide and the discharge capacity of each coin cell according to Examples 1 and 2 and Comparative Examples 1 to 3.

TABLE 2

| | Temperature | | | |
|---|---|---|---|---|
| | Taken out to | | | |
| | Outside of | | Water | Discharge |
| | Furnace | Storing | Content | Capacity |
| | (° C.) | Condition | (ppm) | (mAh/g) |
| Ex. 1 | 250 | dew point −30° | 513 | 226 |
| | | C. or less | | |
| Ex. 2 | 250 | 50% humidity | 760 | 223 |
| Comp. Ex. 1 | 200 | dew point −30° | 1101 | 217 |
| | | C. or less | | |
| Comp. Ex. 2 | 150 | dew point −30° | 1334 | 216 |
| | | C. or less | | |
| Comp. Ex. 3 | 100 | dew point −30° | 1654 | 209 |
| | | C. or less | | |

As shown in Table 2 and FIG. 4, when a coin cell is manufactured using a positive electrode active material (Examples 1 and 2) manufactured by a method satisfying the following conditions 1 or 2, it was found that the discharge capacity of the coin cell is improved than when a coin cell is manufactured using a positive electrode active material (Comparative Examples 1 to 3) manufactured by a method that does not satisfy any of the conditions 1 and 2.
Condition 1: The water content of Na containing transition-metal oxide of P2 type prior to ion-exchange is 1000 ppm or less.
Condition 2: After firing the precursor to obtain a P2 type Na containing transition-metal oxide, the cooling rate from 250° C. to the cooling end temperature is 20° C./min or higher.

Note that, in the above example, the coprecipitation method and spray drying to obtain a precursor containing Na and transition-metal are shown, however, the preparation method of the precursor is not limited thereto. In addition, in the above examples, a precursor and a P2 type Na containing transition-metal oxide having a particular chemical composition are produced and an O2 type positive electrode active material is manufactured using them, however, the chemical composition of O2 type positive electrode active material is not limited thereto. As long as at least one of the above conditions 1 and 2 is satisfied, it is considered that various conditions can be changed.

1. A method of manufacturing a positive electrode active material, the method comprising:
obtaining a Na containing transition-metal oxide having a P2 type structure; and
replacing at least a portion of Na of the Na containing transition-metal oxide with Li by ion-exchange to obtain the positive electrode active material having an O2 type structure, wherein
a water content of the Na containing transition-metal oxide is 1000 ppm or less.

2. A method of manufacturing a positive electrode active material, the method comprising:
firing a precursor containing Na and transition metal elements, followed by cooling to obtain a Na containing transition-metal oxide having a P2 type structure; and
replacing at least a portion of Na of the Na containing transition-metal oxide with Li by ion-exchange to obtain the positive electrode active material having an O2 type structure, wherein
after firing the precursor, a cooling rate from 250° C. to cooling end-temperature is 20° C./min or higher.

3. The method according to claim 2, wherein
the firing the precursor is performed in a heating furnace,
the cooling from 250° C. to the cooling end-temperature is performed outside the heating furnace.

4. The method according to claim 1, wherein
the positive electrode active material has a chemical composition represented by 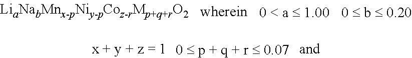
element M is at least one of B, Mg, Al, K, Ca, Ti, V, Cr, Fe, Cu, Zn, Ga, Ge, Sr, Y, Zr, Nb, Mo and W.
